(19) United States
(12) Patent Application Publication
(10) Pub. No.: US 2006/0039583 A1
(43) Pub. Date: Feb. 23, 2006

(54) Method for recording a charcteristic of at least one object

(76) Inventors: Stefan Bickert, Uberlingen (DE); Ulrich Gunther, Uberlingen (DE); Paul Hing, Owingen (DE); Jurgen Wieser, Radolfzell (DE)

Correspondence Address: POSZ LAW GROUP, PLC, 12040 SOUTH LAKES DRIVE, SUITE 101, RESTON, VA, 20191, US

(21) Appl. No.: 10/534,887

(22) PCT Filed: Nov. 12, 2003
(86) PCT No.: PCT/EP03/12612

§ 371 Date: May 13, 2005

(30) Foreign Application Priority Data
Nov. 25, 2002 (DE) 102 55 072.7

(51) Int. Cl. G06K 9/00

(52) U.S. Cl. 382/103; 382/128

(57) ABSTRACT

The invention relates to a method for recording a characteristic of at least one object (28, 56, 68). According to the invention, a) a luminous radiation that is influenced by the object (28, 56, 68) is fed to an image sensor (6), b) at least two different partial images (32, 34, 36, 48, 78, 90, 94, T₁, T₂) consisting of pixels (26) are read out in succession from the image sensor (A₁₁, A₁₂, A₁₃, A₂₁) and values assigned to the pixels (26) are fed to an evaluation unit (10), c) the respective characteristic (B₁₁, B₁₂, B₁₃, B₂₁) of the object is determined from the values that are assigned to a partial image (32, 34, 36, 48, 78, 90, 94, T₁, T₂), d) the partial images (32, 34, 36, 48, 78, 90, 94, T₁, T₂) are combined to form a total image (38), which is output for further processing.

### PRIOR ART

The invention proceeds from a method for detecting a characteristic of at least one object.

U.S. Pat. No. 5,098,426 discloses a method for carrying out a laser operation on the human eye, in the case of which the eye is observed with the aid of two cameras. In this case, one camera is a video camera for outputting video images for a surgeon, and the second camera is a high-speed array sensor that is provided for rapid positioning of the laser. The apparatus for detecting the position of the eye, which permits both rapid tracking of the eye and visual monitoring by the surgeon is very complicated as a result.

It is therefore the object of the invention to specify a method for rapidly detecting a characteristic of an object and for monitoring the object that can be carried out with the aid of a relatively simple apparatus.

This object is achieved by means of a method for detecting a characteristic of at least one object in the case of which, in accordance with the invention,
a. optical radiation influenced by the object is fed to an image sensor,
b. at least two different partial images consisting of pixels are read out in succession from the image sensor, and values assigned to the pixels are fed to an evaluation unit,
c. the characteristic of the object is determined in each case from the values that are assigned to a partial image, and
d. the partial images are combined to form a total image that is output for further processing.

With the aid of only a single image sensor, this method can be used to detect a characteristic of the object, for example the position or speed of the object, very rapidly, that is to say very much in real time, monitoring, for example visual monitoring, of the object being enabled simultaneously. The image sensor can in this case be a cost-effective, commercially available image sensor customary in video technology. However, it is also possible to use a high-speed array sensor. It is merely required that the read-out sequence of the image sensor be freely, or substantially freely, controllable. An apparatus for carrying out the method is disclosed, for example in WO 02/25934 A2.

When determining a characteristic of the object, it is advantageous to be able to determine the characteristic repeatedly in a time sequence that is as rapid as possible. A rapid detection of the characteristic can be achieved by determining the characteristic from a relatively small partial image that can be read out and evaluated rapidly. However, such a partial image does not include the information that is required to monitor the object, for example visually. This information is included in a total image. The invention renders it possible to use images from only one image sensor to obtain a rapid detection of a characteristic of the object in combination with a highly resolving total image. Of course, it is also possible to determine a number of characteristics simultaneously or in sequence.

The optical radiation fed to the image sensor is usually visible light. It is also possible to feed infrared radiation or ultraviolet radiation to the image sensor. The type of the values assigned to the pixels depends on the type of the image sensor. The values can be charge values or voltage values. It is also possible for values of pixels of the partial images to be read out or monitored as early as during an integration or exposure, without the values thereby being considerably influenced. A total image of high intensity can thereby be achieved. Moreover, the exposure can be adapted to a good signal-to-noise ratio. The partial images consisting of pixels can have the same number or different numbers of pixels. Moreover, the pixels of the partial images can be collected on the image sensor (“on-chip pixel binning”). In addition to an immediate reduction in the data volume, this mode of procedure offers the advantage of low noise in relation to the signal.

The shape, the size and the position of the partial images inside the total image are expediently freely selectable. The total image is output for further processing. The processing can be performed, for example, by outputting the total image onto a display screen. It is also possible to process the total image to the effect that only parts of the total image are output, for example on the display screen. Likewise, the total image can be processed in another way, for example being stored or only comparisons of total images being output, or other results obtained from the total image being passed on or output. A partial image comprises a number of pixels that is smaller than the total number of the pixels of the image sensor. The arrangement of the pixels is arbitrary.

A particularly rapid multiply sequential determination of the characteristics of the object is achieved by virtue of the fact that the determination of the characteristics from values of a partial image is performed simultaneously at least in part with the reading-out of a following partial image. After being read out from the first partial image, the values can be fed to the evaluation unit, which determines the characteristic of the object therefrom in a following step. While the evaluation unit is working on determining the characteristic, the values of a second partial image are read out from the image sensor. The reading-out and the evaluation should be performed in this case simultaneously, at least in part, so that the two processes are performed simultaneously at at least one instant.

The partial images advantageously do not overlap one another. As a result, the partial images can be combined rapidly to form a complete total image without gaps and of good resolution. Moreover, the partial images are expediently arranged such that on later combination of the partial images to form a total image all local areas of the total image are covered by partial images. A complete total image is thereby achieved that can easily be evaluated visually. Alternatively, it is also possible for the total image to be combined from partial images not covering all local areas. The areas not covered can be interpolated or extrapolated. Consequently, a total image can be combined from a few partial images or small ones.

In order to detect a characteristic of the object as accurately as possible, it is advantageous when the partial images are assembled from at least two incoherent pixel areas. The pixel areas respectively comprise at least three pixels and do not abut one another anywhere. It can suffice for detecting the characteristic when the object is not completely covered by a partial image, but only sections of the object are detected by the partial image. It is possible thereby to keep the number of pixels of a partial image low and to read out and evaluate the pixel values very rapidly. The incoherent pixel areas are expediently positioned such that they detect areas of the object from which it is possible to conclude the characteristic of the object.

A read-out sequence of the partial images that is particularly simple to control is achieved by assembling the partial images in each case from a number of completely read-out pixel rows of the image sensor. The partial images thereby completely cover the length or the width of the pixel field of the image sensor. However, they are restricted to only a portion of the pixel rows of the pixel field.

It is possible to read out and process the partial images particularly rapidly when the partial images are assembled in each case from a number of only partially read-out pixel rows of the image sensor. In order to detect an object that, for example, covers only a small section of the pixel field of the image sensor, it is not necessary for the partial images to cover the entire length or width of the pixel field. The read-out pixel rows then advantageously cover only the area that is important or expedient for determining the characteristic. As a result, the pixel number of the partial images can be kept low, and reading-out and evaluation can be performed rapidly.

In an advantageous embodiment of the invention, the pixel rows of a partial image are spaced apart from one another in each case by a prescribed number of pixel rows that are not to be read out. A characteristic of the object such as, for example, its position, size, shape or speed of movement, can be detected in this way with the aid of only a small number of pixels. The partial image can cover the object completely without the need to read out every pixel imaging the object. The prescribed number of pixel rows not to be read out can be determined such that it is the same for all row interspaces. Thus, the same number of pixel rows not to be read out are always arranged between the pixel rows to be read out. A uniformly dense coverage of the selected area by the partial image is achieved. However, it is also possible for the pixel rows that are to be read out to be selected at a spacing by means of different numbers of pixel rows not to be read out. The position of the pixel rows to be read out can thereby be directed at the most effective determination possible of the desired characteristic of the object.

In a further advantageous refinement of the invention, the read-out sequence of a second partial image read out following on from a first partial image is offset from the first partial image by a pixel row. The read-out sequence is particularly simple thereby. Moreover, a rapid and simple generation of a complete total image by means of the partial images is achieved, particularly in a regular arrangement of the pixel rows read out.

When the partial images are read out in such a time that at least ten total images per second can be output, the movement of the object can be displayed with little bucking given a visual output of the total images. In an advantageous assembly of a total image from at least ten partial images, at least 100 partial images per second are therefore read out. At least 25 total images are expediently output per second so that the total images can be displayed with little flicker.

A partial image advantageously consists only of so many pixels that the reading-out of a partial image and the determination of the characteristic can be performed within 10 milliseconds in each case. The maximum number of pixels that a partial image can comprise therefore depends on the processing rate of the apparatus carrying out the method. A sufficiently rapid repeated determination of the characteristic is achieved to be able to adapt an appliance, for example a laser surgery appliance for treating a human eye, sufficiently rapidly to the movement of an object.

Particularly advantageous applications of the method are achieved when at least one parameter of the object from the group of position, dimension, shape, change in shape, speed of movement, color, brightness, optical reflection behavior of the object is determined as the characteristic. One or more parameters can be determined from said eight parameters, depending on the application of the method, it being possible when a number of parameters are determined for the results determined to be combined in an entirely general fashion to form new parameters. The position and dimension of the object that are determined can be used, for example, to control a laser appliance employed for medical purposes. Knowledge of the shape and of the change in shape of the object can be used to determine behavior and condition, as well as to classify, identify or reject microorganisms such as cells, bacteria or cultures of fungi. The position, dimension, shape, change in shape and speed of movement of the object can be used to control the read-out sequence of one partial image or of partial images. The partial images can in this way be effectively directed at the object, and the determination of the characteristic can be directed efficiently in terms of time and hardware. The rapid detection of color and, if appropriate, change in color can be used to track and/or influence objects. Rapidly moving marked organisms or, for example, rotten foodstuffs on a conveyor belt can be identified rapidly and, if appropriate, rejected. The knowledge of the brightness and/or the optical reflection behavior of the object can be used, inter alia, when investigating thin or growing layers. The method can thereby be used in physical, biological and chemical processes, in the manufacture or analysis of biochips, or for monitoring rapidly varying structures. The optical reflection behavior is understood, inter alia, as the change in light reflected by the object in relation to the irradiated light such as, for example, wavelength shift, wavelength broadening, light scattering, variation in reflection angle or absorbance during optical reflection.

The computational process in the case of detecting a characteristic of the object can be simplified, and the detection can be carried out reliably when the characteristic is determined with the aid of a prescription of characteristics. A prescription of characteristics is understood as any prescription of a characteristic that the object must fulfill. If, for example, the position of the object is to be determined as characteristic, it is possible to prescribe a shape, for example a circle, that the object must fulfill. The position of the object, which is taken as a circle, is thus determined from the values that are assigned to a partial image. The characteristic can be determined with great reliability from a relatively small number of values by means of this prescription. The number of the values can be reduced by comparison with a method without prescription of characteristics, as a result of which the reading-out and processing of a partial image can be accelerated.

A high degree of flexibility and a high adaptability to a given application can be achieved when the prescription of characteristics is derived from at least one already determined characteristic. When tracking one or more varying objects, a characteristic such as, for example, a shape or a range of shapes may have been determined by evaluating one or a number of partial images. As prescription of characteristics, this characteristic can be prescribed when evaluating one or more following partial images. The characteristic can thereby be detected with high precision from relatively few pixels without the need to determine the characteristic completely again in the case of each partial image.

The read-out sequence of a partial image is expediently controlled with the aid of a characteristic of the object determined from a preceding partial image. The partial image can thus be adapted specifically to the object, as a result of which it is possible to determine the characteristic reliably even with the aid of a partial image comprising only a few pixels. The selection of the pixels of a partial image is fixed in the read-out sequence.

In an advantageous development of the invention, an appliance is controlled with the aid of at least one value obtained from the characteristic of the object. A reliable link between object and appliance, and precise guidance of the appliance can be achieved. The appliance can be a laser appliance for medical treatment of a human organ. It is also possible for the appliance to be an aligning apparatus for positioning the image sensor or an optical irradiation apparatus relative to the object. The image sensor can thereby be readjusted with reference to a moving object. It is likewise advantageously possible for the appliance to be an optical irradiation apparatus that radiates light onto the object, for example, it being possible to detect the brightness of the reflected light as characteristic. It is also conceivable that the appliance is an apparatus for controlling an electrical parameter. The parameter can be a voltage that is applied to a sample vessel and which causes objects in the sample to move. The method is particularly suitable for controlling a robot owing to the rapid detection of objects and the simultaneous possibility of monitoring with the aid of the total image. With the aid of the results of the method, the robot can carry out manipulations at and around the object at high speed, the safety of the robot being ensured by the additional monitoring function. It is also conceivable that the appliance is a bonding or welding appliance, or a classifying apparatus for classification by driving an actuator such as, for example, a pneumatic valve or a magnet.

In a further refinement of the invention, an appliance parameter is regulated in conjunction with at least one value obtained from the characteristic of the object. The appliance parameter can, for example, influence the speed of a moving object, the speed being optimized in the regulating circuit with the aid of a prescription. It is also possible to regulate the irradiation of light onto the object so as to implement the best possible result of the method.

Reliable monitoring of the object can be achieved when the variation in the characteristic of the object is displayed by a sequence of total images. The display can be performed visually, in which case a person monitors the object on a display screen. It is possible to view tissue in vivo or in vitro in conjunction with processing or influencing the tissue. It is also possible to observe, classify or influence organisms, cells or life forms as well as to analyze a body fluid.

### DRAWING

Further advantages emerge from the following description of the drawing. Exemplary embodiments of the invention are illustrated in the drawing. The drawing, the description and the claims include numerous features in combination. The person skilled in the art will expediently also consider the features individually and group them together to form sensible further combinations.

In the drawing:

FIG. 1 shows a schematic of an apparatus for carrying out the method according to the invention,

FIG. 2 shows an illustration of three partial images that are summed up to form a total image,

FIG. 3 shows a schematic of the temporal sequence of the method,

FIG. 4 shows a schematic of a human eye with interpolation points determined for the purpose of calculating the position of the eye,

FIG. 5 shows a schematic sequence of a tracking of an object,

FIG. 6 shows an illustration of the alignment of a sequence of total images with an object, and

FIG. 7 shows a schematic of a monitoring process of the growth of small structures on a substrate.

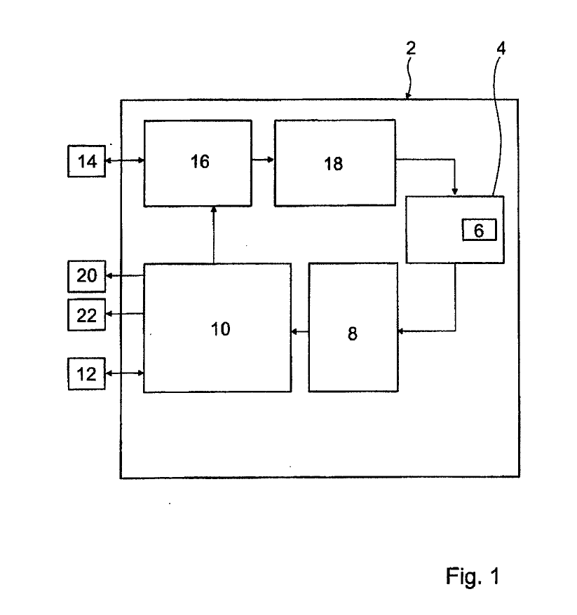

FIG. 1 shows a schematic of an apparatus 2 for carrying out the method according to the invention. The apparatus 2 comprises a device 4 for producing images. Integrated in the device 4 is an image sensor 6 that can be designed as a CCD sensor with charge-coupled components. A CMOS sensor is likewise conceivable. The image sensor 6 is a commercially available sensor such as is used, for example, in video cameras. It has the characteristic that its control can be programmed with regard to mode of operation and with regard to time in such a way that it is possible to define the control of individual pixels, access to the pixels and the displacement of charges with reference to individual pixels and/or rows by means of a signal processing unit, a host computer and a user. Moreover, the read-out sequence in which the individual pixels of the image sensor 6 can be read out can be defined substantially without restriction. The only restrictions are the permissible limits prescribed by the architecture of the image sensor 6.

The electric charges, or analog voltage values, assigned to the individual pixels of the image sensor 6 are fed to a circuit 8. The circuit 8 is adapted to the device 4 and operates digitally, or converts analog signals digitally. The signals output by the circuit 8 are passed on to an evaluation unit 10. The evaluation unit 10 is a device for rapid data processing, for example an electronic DSP system, and executes data processing algorithms. The evaluation unit 10 is distinguished in that it can evaluate the data immediately and rapidly detect changes or events. Direct feedback and control of the mode of operation of the image sensor 6 and/or external units 12 is thereby possible. Evaluation results can be output immediately by the evaluation unit 10. The programming, control and operation of the apparatus 2, for example by a host computer 14 or a user, is performed by a communication device 16. Control and status information, program codes etc. can be received, processed and output again by the communication device 16.

The apparatus 2 further comprises a sensor control 18. The sensor control 18 controls the read-out sequence for reading out the image sensor 6. Those pixels that are to be read out in a read-out operation are specified, together with the timing of the read-out, in the read-out sequence. The read-out sequence also comprises clocking, extinguishing, accessing, reading-out or summing the individual pixels and/or rows, it being possible to read out in any desired sequence. The read-out sequence can differ for each partial image read out from the image sensor 6.

Connected to the apparatus 2 is a video output 20 in which the total images produced by the evaluation unit 10 are output visually onto a display screen. It is also possible for the evaluation unit 10 to pass on partial images to the video output 20, which combines the partial images to form total images. Furthermore, an appliance 22 is connected to the apparatus 2. It is also possible to connect a number of appliances. The appliance 22 can be a laser for medical treatment of a human organ. It is also possible to provide the appliance 22 for positioning the device 4, or for the results determined from the evaluation unit 10 to be processed further in some other way in the appliance 22. A detailed description of an apparatus for carrying out the method is described in WO 02/25934 A2, the disclosure content of this document also being expressly incorporated into this description of the figures.

In conjunction with the methods described with the aid of the following figures, the apparatus 2 is capable of carrying out high-speed image processing, such as pattern recognition, for example, with the aid of an associated real-time feedback control and the production of visual images for monitoring an operation.

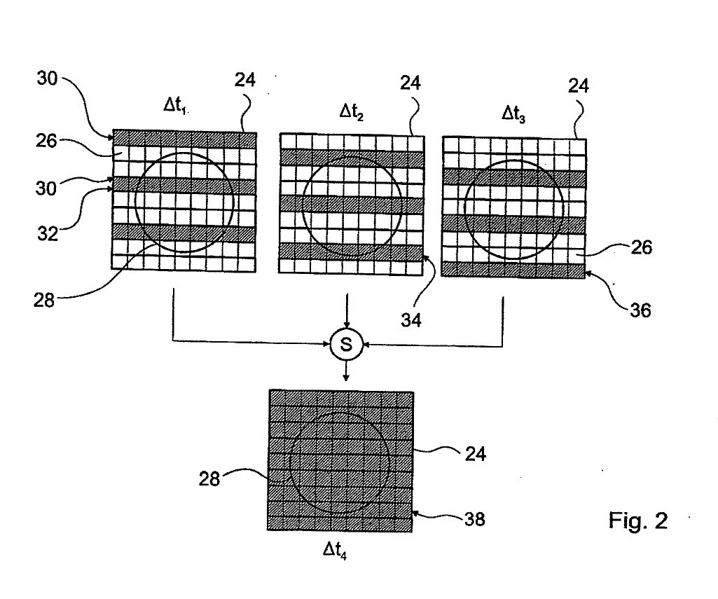

Main features of the method are described in FIG. 2. An object 28 is illuminated such that light reflected by the object 28 impinges on the image sensor 6. The image sensor 6 has a pixel field 24 that, for the purpose of clarity, is assembled from only 9×9 pixels 26. All the pixels 26 of the pixel field 24 together image the object 28. The image sensor 6 is driven by the sensor control 18 such that three pixel rows 30 are read out within a first time interval Δt₁ from the pixel field 24 of image sensor 6, and specifically the first row and the fourth and seventh rows. These pixel rows 30 are marked by hatching in FIG. 2. The first partial image 32 therefore consists of three incoherent pixel areas. The values assigned to the individual pixels 26 of the read-out pixel rows 30 are fed to the evaluation unit 10 via the circuit 8. The three read-out pixel rows 30 form a first partial image 32. The partial image 32 is assembled from the pixels 26 that are arranged in three completely read-out pixel rows 30 within the pixel field 24 of the image sensor 6. Arranged between the pixel rows 30 of the partial image 32 are in each case two pixel rows that are not read out within the first time interval Δt₁.

Within a later second time interval Δt₂, a second partial image 34 is read out from the pixel field 24 of the image sensor 6 under the control of the sensor control 8. The second partial image 34 is assembled, in turn, from three pixel rows 30 that are likewise separated from one another by two pixel rows not read out within the time interval Δt₂. The partial image 34 is assembled from the pixels 26 of the second, fifth and eighth pixel rows 30 of the pixel field 24 of the image sensor 6. The partial image 34 therefore differs from the partial image 32 in that the read-out sequence of the second partial image 34 is offset by one pixel row with reference to the read-out sequence of the first partial image 32. The values assigned to the pixels 26 of the read-out pixel rows 30 of the second partial image 34 are likewise fed to the evaluation unit 10. The three partial images 32, 34, 36 are arranged such that they do not overlap.

A third partial image 36 is read out from the pixel field 24 of the image sensor 6 in a time interval Δt₃ which is likewise later. By comparison with the second partial image 34, the third partial image 36 is once again arranged displaced downward by one pixel row and is otherwise the same as the two preceding read-out partial images 32 and 34. Again, the values resulting from the third partial image 36 are fed to the evaluation unit 10 for further evaluation.

Image summing S is carried out in the evaluation unit 10. This image summing S yields a total image 38 that is assembled from the partial images 32, 34, 36. The total image 38 covers all the pixels 26 of the pixel field 24 of the image sensor 6. The object 28 is completely imaged by the total image 38. The total image 38 is output visually within a fourth time interval Δt₄ on a display screen of the video output 20. The fourth time interval Δt₄ is approximately exactly as long as the sum of the three time intervals Δt₁ to Δt₃. While the total image 38 is being displayed on the display screen, further partial images are read out from the image sensor 6, a fourth partial image having a read-out sequence identical to that of the first partial image—except for the read-out instant—and the fifth partial image also corresponding to the second partial image 34.

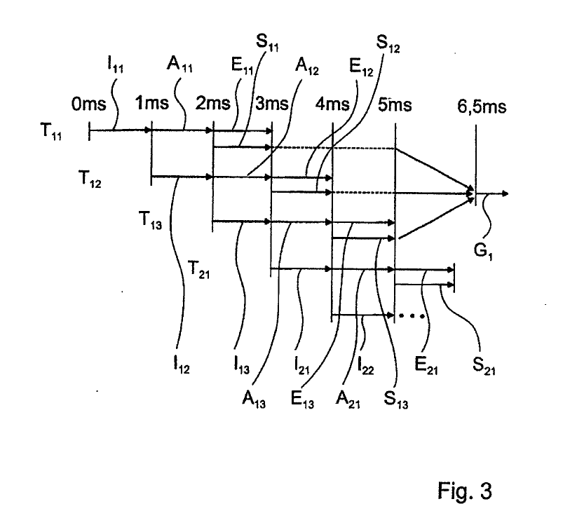

One possibility for a temporal sequence of the method is shown in FIG. 3. The integration I₁₁ of a first partial image T₁₁ begins at a first instant, which is marked with 0 ms in FIG. 3. Here, charges reduced by the action of light are summed in the pixels 26 of the image sensor 6 that are assigned to the first partial image T₁₁. This process lasts 1 millisecond (ms), for example, and ends at the instant that is marked with 1 ms in FIG. 3. At this instant, the sensor control 18 directs that the pixels 26 assigned to the first partial image T₁₁ be read out A₁₁. In the exemplary sequence shown in FIG. 3, the reading-out A₁₁ also lasts 1 ms and ends at an instant that is 2 ms later than the start of the method and is marked with 2 ms. The values read out from the image sensor 6 are subsequently fed to the evaluation unit 10 which, in turn, evaluates the values within a time interval of 1 ms and determines E₁₁ therefrom a characteristic of an object being viewed. The read-out values are stored S₁₁ by the evaluation unit 10 within the same time interval of 2 ms to 3 ms. The characteristic, calculated by the determination E₁₁, of the object 28, for example its position, size or its optical reflection behavior is also likewise stored or passed on to a communication device 16 or to an appliance 22 or to some other unit 12.

The pixels assigned to a second partial image T₁₂ are integrated I₁₂ during the same period of time in which the pixels assigned to the first partial image T₁₁ are read out from the image sensor 6. The integration I₁₂ and the reading-out A₁₁, taking place at the same time, need not, as represented in FIG. 3 for the sake of simplicity, take place entirely synchronously here, but can also overlap one another temporally only partially. Thus, the read-out operation A₁₁ can be performed, for example, in a shorter time interval than the integration I₁₂. The operation, assigned to the second partial image T₁₂, of integrating I₁₂, reading-out A₁₂ and determining E₁₂ one or more characteristics of the object, and the storage S₁₂ of the read-out values proceed essentially identically, as is described above with reference to the first partial image T₁₁, the sequences assigned to the second partial image T₁₂ taking place in each case 1 ms later than for the first partial image T₁₁.

The pixels that are assigned to a third partial image T₁₃ are integrated I₁₃ and read out A₁₃ in a fashion likewise offset backwards in time by 1 ms by comparison with the second partial image T₁₂, and the values are stored S₁₃. As in the case of the preceding partial images T₁₁ and T₁₂, the characteristic or the characteristics of the object is/are determined E₁₃ simultaneously at least in part with the storage S₁₃ of the read-out pixel values. As is easy to see from FIG. 3, the operations of integrating Iᵢᵢ, reading out Aᵢᵢ and calculating or determining Eᵢᵢ the characteristic or the characteristics of the object, as well as of storing Sᵢᵢ the read-out values are performed simultaneously in relation to an arbitrary time interval. For the sake of clarity, the time sequences illustrated in FIG. 3 are simplified, there being no need for the simultaneity to be complete.

Owing to the small number of pixels of the individual partial images Tᵢᵢ, the time intervals, which are given as 1 ms by way of example in FIG. 3, can be kept very short. The method can be carried out extremely rapidly, since the various method steps are executed synchronously. One or more characteristics of the object being viewed can therefore be determined in a very rapid time sequence one after another.

After the operation of determining E₁₃ the characteristics determined from the third partial image T₁₃ is terminated, this instant being given in FIG. 3 as 5 ms, the values determined from the partial images T₁ᵢ are passed on to the video output 20 by the evaluation unit 10. The values assigned to the partial images T₁ᵢ are combined to form a total image in the video output 20 and subsequently displayed G₁ on a monitor. The beginning of the display G₁ of the first total image is given at 6.5 ms by way of example in FIG. 3.

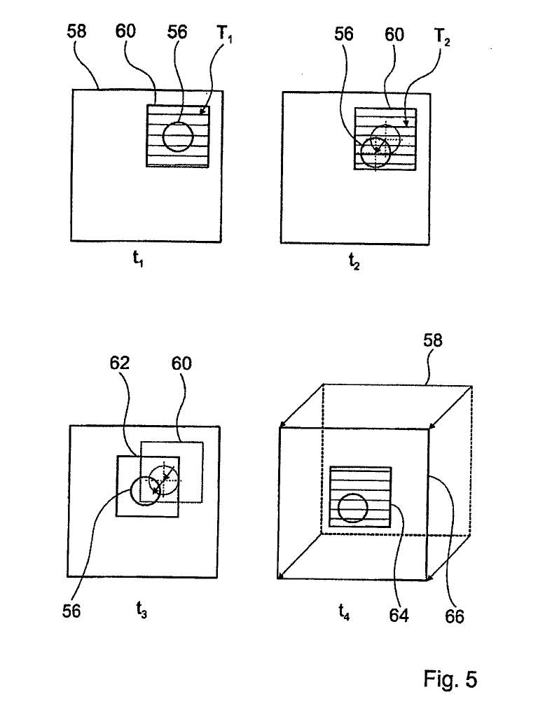

After the integration I₁₃ of the last partial image T₁₃, which is assigned to the first total image, has been ended, the pixels that are assigned to a next first partial image T₂₁ are integrated I₂₁. The pixel composition of the next first partial image T₂₁ can be identical to that of the first partial image T₁₁ mentioned above. It is also conceivable for the pixel compositions of the partial images T₂₁ and T₁₁ to deviate from one another, as is illustrated by way of example in FIG. 5. Just as with the first partial image T₁₁, the procedure with the next first partial image T₂₁ is also the same, the pixels assigned to this partial image T₂₁ being integrated I₂₁, read out A₂₁ and stored S₂₁. Characteristics of the object are determined E₂₁ synchronously with the storage S₂₁, at least in part. The partial image T₂₁ is later displayed in a second total image on a display screen by the video output 20.

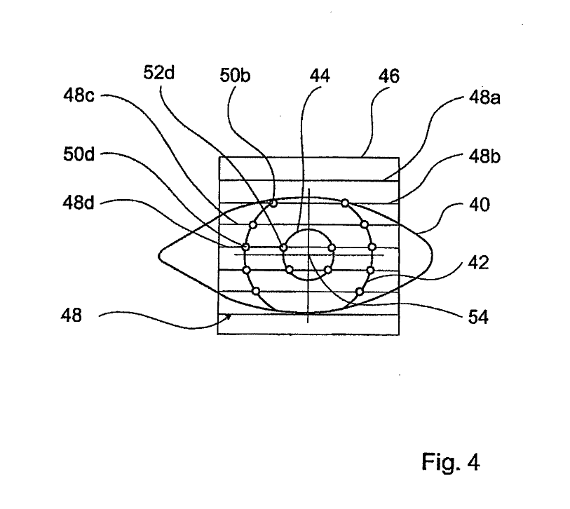

An eye 40 is shown schematically in FIG. 4. The eye 40 has an iris 42 of which only the outer circumference is illustrated in FIG. 4. The pupil 44 is illustrated inside the iris 42, likewise only with the aid of a single line. Light emerging from the eye 40 falls into the image sensor 6 such that the pixels of the image sensor 6, which are not illustrated individually in FIG. 4, image the iris 42 completely and also image the eye 40 completely except for its outermost regions. The total pixel field 46 is assembled from a number of n×n pixels 26, which are not shown individually in FIG. 4.

Likewise illustrated in FIG. 4 is a partial image 48 that is assembled from seven pixel rows 48a, 48b, 48c etc. The values assigned to the pixel rows 48a, 48b etc. are evaluated in the evaluation unit 10, the gray scale value profile from one pixel to the next being reproduced in a function. This function is investigated for a point of inflection, for example, with the aid of a presciption of characteristics. The difference in the gray scale values of two neighboring pixels is particularly large at such a point of inflection. It is possible in this way for the evaluation unit 10 to determine points in the eye 40 that are denoted in what follows as interpolation points 50b, 50d, 50e etc. In the example shown in FIG. 4, it was not possible to determine any interpolation points from the pixel row 48a, two interpolation points 50b result from the pixel row 48b, and four interpolation points 50d and 52d result from the pixel row 48d. The contour both of the iris 42 and of the pupil 44 is determined from these interpolation points 50b, 50d and 52d with the aid of the further prescription of characteristics that both the iris 42 and the pupil 44 are to be considered as circular. The center 54 of the iris 42 and of the pupil 44 is then calculated from these contours. The position of the iris 42 is determined as characteristic with the aid of the center 54 in this way, which is greatly simplified for the sake of clarity. The position determined can now be passed on by the evaluation unit 10 to an appliance 22 that, for example, controls a medical laser for carrying out an eye operation. Since only relatively few interpolation points 50b, 50d, 52d, and thus only a few pixel rows are required to calculate the position of the iris 42, the calculation of the center 54 or of the position of the iris 42 is completed very rapidly.

The pixel values assigned to the partial image 48 are stored in the evaluation unit 10 and combined at a later instant to form a total image. This total image is transmitted by the evaluation unit 10 to the video output 20 and displayed there on a monitoring display screen for a surgeon. The surgeon thus sees the iris 42 completely and at high resolution on his monitoring display screen and can therefore carry out and monitor the operation. The integration, reading-out and calculation of a characteristic with reference to a partial image 48 lasts less than 1 ms in each case. More than 1000 partial images per second are therefore calculated, as are more than 1000 characteristics or positions of the iris 42. These positions can be used to control a medical laser in such a way that it, given a movement of the iris 42, is either tracked, or firstly switched off and then tracked. The individual operations are performed so rapidly that they are not displayed in detail to the surgeon. The surgeon sees only the highly resolved complete image of the iris 42, in which the instantaneous position of the laser is also displayed. The repetition rate of the total images is 40 Hz. A total image comprises in each case more than 25 partial images.

FIG. 5 shows, schematically, how the movement of an object 56 is tracked. An object 56 is imaged within a pixel field 58 of an image sensor. The object 56 fills up only a small part of the total pixel field 58. The size of the object 56 was determined in a sequence of partial images, the object 56 having been assigned a total image field 60. The total image field 60 covers only a small part of the pixel field 58 of the image sensor. Starting from an instant t₁, a first partial image T₁ is recorded only within the total image field 60. The partial image T₁ comprises six pixel rows. As described in relation to FIG. 4, the position of the object 56 is determined from the values assigned to the partial image T₁.

Starting from a second instant t₂, a partial image T₂ is once again recorded. Further partial images can have been recorded between the partial images T₁ and T₂. The position of the object 56 is recalculated from the values that are assigned to the partial image T₂. At the instant t₂, the object 56 is located in another position than at the instant t₁ and, as illustrated in FIG. 5, has migrated a little further down to the left. The evaluation unit 10 determines the speed of movement of the object 56 as further characteristic of the object 56 from the migration of the object 56. This speed of movement is used to calculate when the object 56 abuts the boundaries of the total image field 60.

At an instant t₃, before this calculated instant, the evaluation unit 10 drives the sensor control 18 in such a way that partial images that come to lie in a new total image field 62 are read out starting from the instant t₃. The displacement of the total image field 62 in relation to the total image field 60 is adapted to the speed of movement of the object 56 in such a way that the partial images recorded by the image sensor always completely cover the object 56. The position of the object 56 is determined in turn from a partial image recorded at the instant t₃ and not shown in FIG. 5, the position of the object 56 not corresponding to the position calculated from the speed of movement. The size of the total image field 62 is, however, selected such that the object 56 is still completely covered nevertheless by the total image field 62 in the event of a deviation of the position.

At a later instant t₄, the total image field 64 has already migrated further with the object 56 and comes to lie substantially at the edge of the pixel field 58 of the image sensor. As it moves, the object 56 risks running out of the pixel field 58. This is detected by the evaluation unit 10, which controls an appliance 22 in such a way that the position of the image sensor follows up the movement of the object 56 in a prescribed way. At the instants following the instant t₄, the position of the pixel field 66 of the image sensor is therefore displaced by comparison with the pixel field 58 such that the total image field 64 can again follow the movement of the object 56. At the instants shown in FIG. 5, the partial images respectively cover only the area of the respective total image field 60, 62, 64. The partial images are therefore assembled in each case from a number of only partially read-out pixel rows of the image sensor. The total image output, or passed on for further processing, therefore likewise covers the surface of the respective total image field 60, 62, 64. Consequently, only the image section respectively relevant with reference to the object 56 is displayed in a total image to a human monitor or a monitor unit.

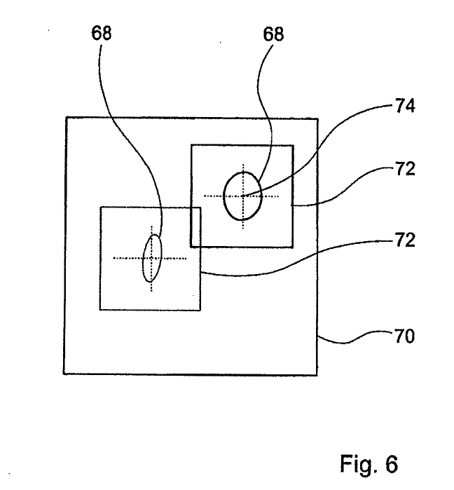

FIG. 6 shows the tracking of an object 68 whose shape varies in the course of time. As in FIG. 5, only a section from the total pixel field 70 of an image sensor is evaluated in a total image field 72 and output in a total image. As described above, the object 68 is tracked with the aid of a sequence of partial images, a center 74 of the object respectively being determined with the aid of a computational formula. This center 74, which is to be understood as the position of a object 68, also forms the center of the total image field 72, which thus continuously follows the slow movement of the object 68. At a later instant, the total image field 72 is located at the position shown by dashes in FIG. 6. At the same time, the object 68 is likewise located in the dashed position.

In the partial image that is assigned to the solid position of the object 68, the shape of the object 68 is also calculated in addition to the center 74 of the object 68. This shape is prescribed as a prescription of characteristics during calculation of the shape of the object 68 in a following partial image, a deviation of the shape being permitted. Owing to this prescription of characteristics, the calculation of the shape and the position of the object 68 in the partial image can be carried out in a simplified fashion, since only specific shapes and positions are possible. The number of the pixels to be read out per partial image can thereby be kept low. Each partial image can therefore be read out very rapidly, and the characteristic can be calculated very rapidly.

Because a change in the shape of the object 68 is also permitted in the prescription of characteristics, the prescription of characteristics, which is passed on from partial image to partial image, is adapted to the current shape of the object 68. It is also possible to adjust the prescription of characteristics only in each case after a number of partial images. The position and shape of the object 68 can thereby be tracked in a very efficient and rapid way.

The selection of the pixels of a partial image is adapted to the shape of the object 68. It is therefore also possible for a partial image to cover only a part of the total image field. This partial image is possibly not taken into account during a later assembly of a total image, because enough partial images are available even without this partial image in order to provide a human monitor with a total image free from flicker. This partial image therefore serves only for calculating the characteristics.

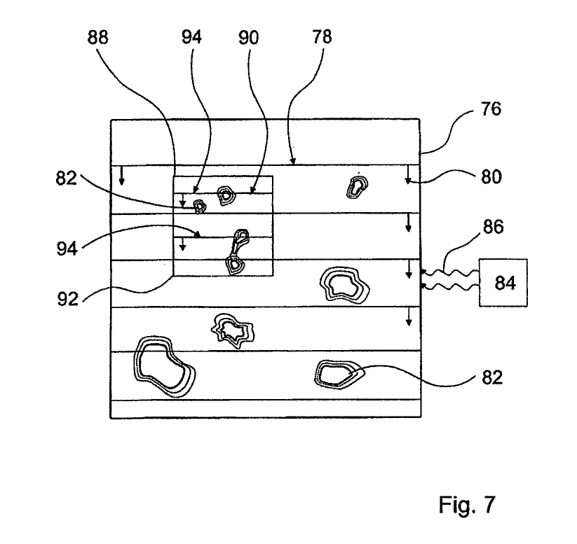

A further possibility for applying the method is illustrated in FIG. 7. A pixel field 76 of an image sensor is read out with a sequence of partial images 78. The partial images 78 respectively consist of six pixel rows, an immediately following partial image 78 being displaced downward by comparison with the preceding partial image 78 by one pixel row in each case. This is indicated by the arrows 80. The pixel field 76 is arranged on a carrier plate on which a number of biological cultures 82 are mounted. These cultures 82 are irradiated with light 86 by an appliance 84 and grow in the course of time, this being indicated by the dashed lines. The cultures 82 are intended in this case to grow as far as possible such that they assume a largely round shape.

The rate of growth of the cultures 82 and thus, bound up with this, the shape of the cultures can be influenced by the intensity of the irradiated light 86. With the aid of the values from the individual partial images 78, the instantaneous shape of the individual cultures 82 is determined in each case and monitored in an evaluation unit. If it is established in the evaluation unit that the cultures 82 are developing unfavorably beyond a fixed measure, the appliance 84 is driven in such a way that the intensity and, if appropriate, the frequency of the irradiated light are varied. A control loop is thereby traversed. The growth of the cultures 82 continues to be observed, and the intensity or frequency of the light is regulated in accordance with the growth of the cultures 82.

It is possible that an operator can also direct a total image field firstly aligned with the pixel field 76 onto a specific critical area 92. FIG. 7 illustrates such an area, at which a number of cultures 82 grow together in the course of time. The operator can reduce the total image field of the pixel field 76 to a new total image field 88 and monitor this site separately and with particular fineness. It is possible thereby to cause the partial images to continue traversing the entire pixel field 76, or to select new partial images 90 from the total pixel field 76 of the image sensor only in such a way that the partial images 90 traverse only the total image field 88.

It is also possible in a further variant embodiment that although an operator is always shown only a total image corresponding to the pixel field 76, an evaluation unit automatically selects a surface in which additional partial images 94 are being produced. An additional pixel row, which belongs to the partial image 94, is arranged intermediately in FIG. 7 between each pixel row of the partial image 78. Consequently, the partial image 94 is also recorded in addition to the partial image 78, the recording of the partial images 78, 94 being possible simultaneously or one after another. A particularly exact and particularly rapid monitoring of the cultures 82 located within the surface 92 is thereby achieved. It is thereby possible to direct control of the appliance 84 and corresponding irradiation of the cultures 82 with light 86 specifically at the critical cultures 82 within the area 92. The result of this is a very rapid and particularly efficient control of the appliance 84 onto one or more critical areas 92.

### LIST OF REFERENCE SYMBOLS

2 Apparatus
4 Device
6 Image sensor
8 Circuit
10 Evaluation unit
12 Unit
14 Host computer
16 Communication device
18 Sensor control
20 Video output
22 Appliance
24 Pixel field
26 Pixel
28 Object
30 Pixel row
32 Partial image
34 Partial image
36 Partial image
38 Total image
40 Eye
42 Iris
44 Pupil
46 Pixel field
48 Partial image
48a Pixel row
48b Pixel row
48c Pixel row
48d Pixel row
50b Interpolation point
50d Interpolation point
52d Interpolation point
54 Center
56 Object
58 Pixel field
60 Total image field
62 Total image field
64 Total image field
66 Pixel field
68 Object
70 Pixel field
72 Total image field
74 Center
76 Pixel field
78 Partial image
80 Arrow
82 Culture
84 Appliance
86 Light
88 Total image field
90 Partial image
92 Area
94 Partial image
Δt₁ Time interval
Δt₂ Time interval
Δt₃ Time interval
Δt₄ Time interval
S Image summing
T Partial image
Tᵢᵢ Partial image
Iᵢᵢ Integration
Aᵢᵢ Reading-out
Eᵢᵢ Determination
Sᵢᵢ Storage
G₁ Display
t₁ Instant
t₂ Instant
t₃ Instant
t₄ Instant

1. A method for detecting a characteristic of at least one object, in which
a. optical radiation influenced by the object is fed to an image sensor,
b. at least two different partial images consisting of pixels are read out in succession from the image sensor, and values assigned to the pixels are fed to an evaluation unit,
c. the characteristic of the object is determined in each case from the values that are assigned to a partial image, and
d. the partial images are combined to form a total image that is output for further processing.

2. The method as claimed in claim 1, wherein the determination of the characteristics from values of a partial image is performed simultaneously at least in part with the reading-out of a following partial image.

3. The method as claimed in claim 1, wherein the partial images do not overlap one another.

4. The method as claimed in claim 1, wherein the partial images are assembled from at least two incoherent pixel areas.

5. The method as claimed in claim 1, wherein the partial images are assembled in each case from a number of completely read-out pixel rows of the image sensor.

6. The method as claimed in claim 1, wherein the partial images are assembled in each case from a number of only partially read-out pixel rows of the image sensor.

7. The method as claimed in claim 5, wherein the pixel rows of a partial image are spaced apart from one another in each case by a prescribed number of pixel rows that are not to be read out.

8. The method as claimed in claim 5, wherein the read-out sequence of a second partial image read out following on from a first partial image is offset from the first partial image by a pixel row.

9. The method as claimed in claim 1, wherein the partial images are read out in such a time that at least 10 total images per second can be output.

10. The method as claimed in claim 1, wherein a partial image consists of only so many pixels that the reading-out of a partial image and the determination of the characteristic can be performed within 10 ms in each case.

11. The method as claimed in claim 1, wherein at least one parameter of the object from the group of position, dimension, shape, change in shape, speed of movement, color, brightness, optical reflection behavior of the object is determined as the characteristic.

12. The method as claimed in claim 1, wherein the characteristic is determined with the aid of a prescription of characteristics.

13. The method as claimed in claim 12, wherein the prescription of characteristics is derived from at least one already determined characteristic.

14. The method as claimed in claim 1, wherein the read-out sequence of a partial image is controlled with the aid of a characteristic of the object determined from a preceding partial image.

15. The method as claimed in claim 1, wherein an appliance is controlled with the aid of at least one value obtained from the characteristic of the object.

16. The method as claimed in claim 15, wherein an appliance from the group of
a laser appliance for operating on an eye, an aligning apparatus for positioning the image sensor relative to the position of the object, an optical irradiation apparatus, an apparatus for controlling an electrical parameter, a robot is controlled.

17. The method as claimed in claim 1, wherein an appliance parameter is regulated in conjunction with at least one value obtained from the characteristic of the object.

18. The method as claimed in claim 1, wherein the variation in the characteristic of the object is displayed by a sequence of total images.
